(19) United States
(12) Patent Application Publication
(10) Pub. No.: US 2005/0001534 A1
(43) Pub. Date: Jan. 6, 2005

(54) Field emission display device

(76) Inventor: Seong Hak Moon, Seoul (KR)

Correspondence Address: BIRCH STEWART KOLASCH & BIRCH, PO BOX 747, FALLS CHURCH, VA, 22040-0747, US

(21) Appl. No.: 10/880,544

(22) Filed: Jul. 1, 2004

(30) Foreign Application Priority Data
Jul. 3, 2003 (KR) 10-2003-0045020

(51) Int. Cl. H01J 1/62; H01J 63/04; H01J 1/00

(52) U.S. Cl. 313/495; 313/496; 313/497

(57) ABSTRACT

A field emission display device can improve a contrast, prevent a spread of an electron beam, and prevent overlapping and distortion of an image by mixing a black material that can absorb an electron with an existing material to form a spacer ground layer and a buffer layer or by forming a black material layer made of a black material on the spacer ground layer, to absorb an electron reflected from an anode electrode or a fluorescent material.

### BACKGROUND OF THE INVENTION

1. Field of the Invention

The present invention relates to a field emission display, and particularly, to a field emission display device capable of improving a contrast, preventing a spread of an electron beam, and a double image, by absorbing an electron beam reflected from an anode electrode by using a black material.

2. Description of the Background Art

As information and communication technologies are rapidly developed and various information is required to be visualized, a demand for an electron display device is more increased and a required figure thereof is also varied. As an example, a display device whose weight, size and energy consumption are small is required in an environment where mobility is emphasized, such as a portable information device, and a display device having a wide screen whose angular field is wide is required in case that a display device is used as information transmission media for the public. In addition, since a display device for satisfying such requirements should be large and flat and have a low price, high performance, high definition and light weight, a development of a light, thin and flat panel display device which can substitute for an existing CRT is really needed.

A CRT, which occupies most of current information display media, is excellent in performance. But, the CRT is disadvantageous in that, as a screen becomes large, its size and weight are increased and a high voltage and much energy are consumed. Therefore, a development of a flat panel display device is necessary. Among flat panel display devices which are being developed or manufactured, a liquid crystal display (LCD) device, a plasma display panel (PDP) device, a vacuum fluorescent display (VFD) device and the like are being commercialized by current large makers. In addition, a field emission display (FED) device which is expected to be put to practical use in the near future is drawing attention as a flat plane display device for next-generation information and communication, which overcomes all defects of other display devices.

Especially, an MIM field emission display (Metal-Insulator-Metal Field Emission Display) has advantages a display device should have, such as a simple electrode structure, a high operation speed, a perfect color, a perfect gradation, high brightness and a high image transmission speed and the like. Such a field emission display device has a high vacuum region for emission of an electron between an upper plate and a lower plate to which a high voltage is applied, and uses a quantum-mechanical tunneling phenomenon that electrons come out of a vacuum from metal or a conductor when a high electric field is applied onto metal or a conductor in the high vacuum region.

FIG. 1 is a sectional view illustrating a conventional field emission display device.

As shown therein, the conventional field emission display device includes an anode upper substrate having a fluorescent material 1 and an anode electrode 2; a scan electrode 10 for emitting an electron on a lower glass substrate 9; a tunnel insulation film 7 which is a path through which an electron emitted from the scan electrode 10 is emitted; a data electrode 4 for generating an electric field to control intensity of an electron when a voltage is applied thereto; a field insulation film 8 for electrically insulating the data electrode 4 and the scan electrode 10; a spacer ground layer 5 for earthing the following spacer 3; a cathode lower substrate having a buffer layer 6 for electrically insulating the spacer ground layer 5 and the data electrode 4; and a spacer 3 supporting the upper substrate and a lower substrate therebetween.

FIG. 2 is an exemplary view illustrating a region where an electron is re-reflected in a field emission display device in accordance with the conventional art.

As shown therein, the conventional field emission display device has a matrix form and consists of a region 20 where an electron which has passed through the scan electrode and the tunnel insulation film 7 is emitted; and a region 30 where the emitted electron is reflected by the anode electrode 2 and the reflected electron is re-reflected by the spacer ground layer 5. Herein, in the conventional art, the spacer ground layer 5 is made of aluminum (Al), and the buffer layer 6 is made of an insulating material including a reflection material.

Operations of the field emission display device constructed as above will now be described with reference to FIGS. 1 and 2.

First, when a certain voltage is applied to the data electrode 4 and the scan electrode 10, an electron is emitted from the scan electrode 10, and the electron is emitted through the insulation film 7 and the data electrode 4 by a quantum-mechanical tunneling effect. At this time, when the certain voltage is large, the amount of electrons emitted from the scan electrode 10 becomes many, and when the certain voltage is small, the amount of emitted electrons becomes few.

Thereafter, the emitted electrons is moved accelerated toward the anode to which a fluorescent material has been applied, by an anode voltage, to collide with the fluorescent material, thereby generating energy. Thereafter, when electrons existing in the fluorescent material are excited by this energy and then falls off, visible rays are emitted.

In the conventional field emission display device, a part of electrons which have collided with the anode electrode 2 or the fluorescent material 1 is reflected, and the reflected electrons are re-reflected by the spacer ground layer 5, a re-reflection region 30 made of aluminum (Al), to collide with the fluorescent material 1. Thus, when the electrons in the fluorescent material 1 are excited and then falls off again, visible rays are re-emitted.

FIG. 3 is an exemplary view illustrating overlapping of an image, which occurs in the conventional field emission display device.

As shown in FIG. 3, in the conventional field emission display device, a circular image is doubly or triply overlapped due to re-reflection of the reflected electron. That is, since electrons having been reflected from the anode electrode 2 and the fluorescent material 1 are re-reflected by the spacer ground layer 5 made of aluminum and a part of the buffer layer 6 including a reflection material, an image is doubly or triply overlapped.

### SUMMARY OF THE INVENTION

Therefore, an object of the present invention is to provide a field emission display device capable of improving a contrast, preventing a spread of an electron beam, and preventing overlapping and distortion of an image by applying a black material onto every region except a field emission region or by mixing a black material for absorbing an electron beam with an existing material causing reflection.

To achieve these and other advantages and in accordance with the purpose of the present invention, as embodied and broadly described herein, there is provided a field emission display device including: an anode upper substrate including a fluorescent material and an anode electrode for performing light-emitting when an electron collides with the fluorescent material; a cathode lower substrate including an electron absorbing material, which absorbs an electron reflected from the anode electrode, in a predetermined region except a field emission structure for light-emitting of an electron; and a spacer for supporting the upper substrate and the lower substrate therebetween.

To achieve these and other advantages and in accordance with the purpose of the present invention, as embodied and broadly described herein, there is provided a field emission display device including: an anode electrode for performing light-emitting when an electron collides with a fluorescent material; a field emission structure including a scan electrode for emitting an electron and a data electrode for generating an electric field to control intensity of an electron when a voltage is applied thereto; and a black material including an organic material of carbon series and a chrome (Cr) as metal material, and for absorbing an electron reflected from the anode electrode onto the field emission structure.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a sectional view illustrating a conventional field emission display device;

FIG. 2 is an exemplary view illustrating a region where an electron is re-reflected in a field emission display device in accordance with the conventional art;

FIG. 3 is an exemplary view illustrating overlapping of an image, which occurs in a conventional field emission display device;

FIG. 4A is a sectional view illustrating a structure of a field emission display device in accordance with the present invention;

FIG. 4B is a sectional view illustrating a structure of a different embodiment of a field emission display device in accordance with the present invention;

FIG. 5 is an exemplary view illustrating a region where an electron is emitted and a region where an electron is absorbed in a field emission display device in accordance with the present invention; and

FIG. 6 is an exemplary view illustrating a state that overlapping of an image does not occur in a field emission display device in accordance with the present invention.

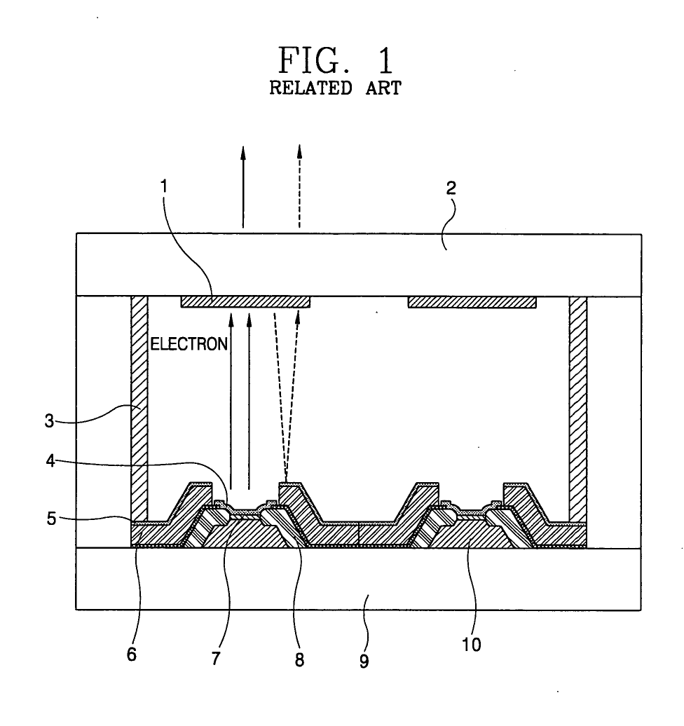

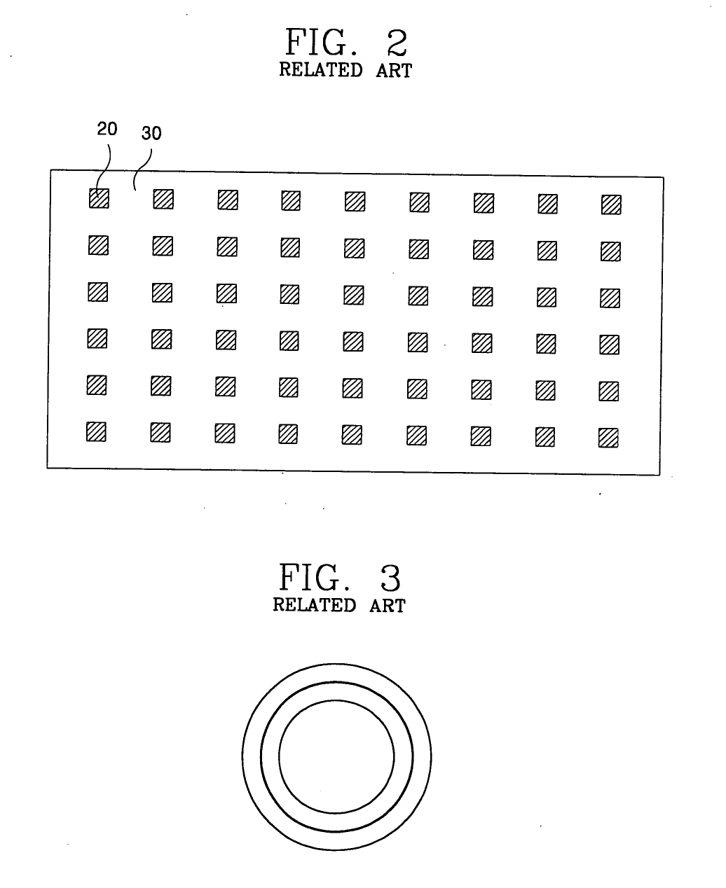

### DETAILED DESCRIPTION OF THE PREFERRED EMBODIMENTS

Reference will now be made in detail to the preferred embodiments of the present invention, examples of which are illustrated in the accompanying drawings.

A preferred embodiment of a field emission display device capable of improving a contrast, preventing a spread of an electron beam, and preventing overlapping and distortion of an image by mixing a black material that can absorb an electron with an existing material to form a spacer ground layer and a buffer layer, or by forming a black material layer made of a black material on the spacer ground layer, to absorb an electron reflected from an anode electrode or a fluorescent material, will now be described with reference to accompanying drawings.

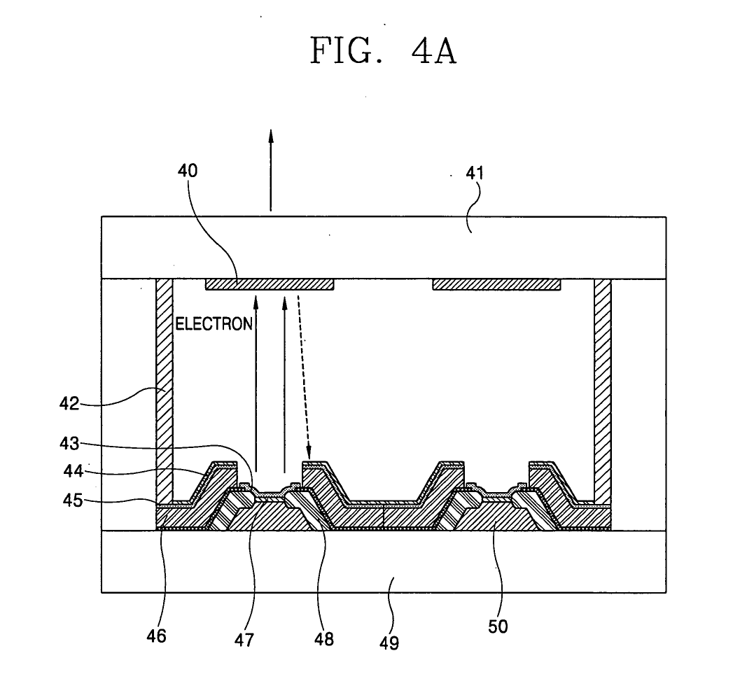

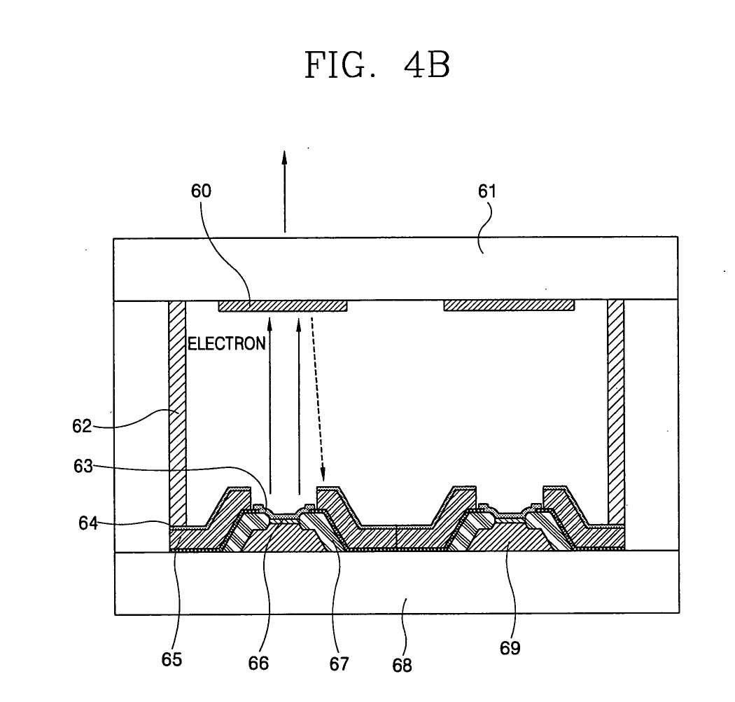

FIG. 4A is a sectional view illustrating a structure of a field emission display device in accordance with the present invention.

As shown in FIG. 4A, the field emission display device in accordance with the present invention includes: an anode upper substrate having an RGB fluorescent material 40 and an anode electrode 41 having a lower portion to which the fluorescent material 40 is applied and for performing light-emitting when an emitted electron collides with the fluorescent material; a cathode lower substrate having a field emission structure; and a spacer 9 for supporting the upper substrate and the lower substrate therebetween. Herein, the cathode lower substrate includes: a scan electrode 50 for emitting an electron onto a lower glass substrate 49; a tunnel insulation film 47, which is a path through which an electron emitted from the scan electrode 50 is emitted; a data electrode 43 for generating an electric field to control intensity of an electron when a voltage is applied thereto; a field insulation film 47 for electrically insulating the data electrode 43 and the scan electrode 50; a spacer ground layer 45 for earthling the spacer 9; a buffer layer 46 for electrically insulating the spacer ground layer 45 and the data electrode 43; and a BM layer 44 made of a black material for absorbing an electron reflected from the anode electrode 41 or the fluorescent material 40 on the spacer ground layer 45. The scan electrode 50, the tunnel insulation film 47, the data electrode 43 and the field insulation film 47 for performing emission of an electron are referred to as a field emission structure. In addition, the black material (BM) layer includes an organic material of carbon series and a chrome (Cr) as metal material.

The field emission display device according to the abovementioned construction operates as follows.

When an anode voltage is applied between a data electrode 43 and a scan electrode 50 on a lower substrate, a strong magnetic field is formed by an IS electron emitting source of metal positioned therebetween, and an electron is emitted by quantum-mechanical tunneling effect. Thereafter, the electron emitted through the field emission structure is moved toward an anode electrode 41 on an upper substrate to which a voltage of hundreds or thousands of volts has been applied, to collide with an RGB fluorescent material 40 applied onto the anode electrode. An electron included in the fluorescent material 40 is excited by energy generated through the collision, so that cathode rays are emitted. At this time, a part of electrons emitted from the anode electrode 41 is reflected to the lower substrate, and the reflected electron is absorbed by a black material layer 44 made of a black material (BM) on the spacer ground layer 45, so that the electrons are not re-reflected to the anode electrode 41.

FIG. 4B is a sectional view illustrating a structure of a different embodiment of a field emission display device in accordance with the present invention.

As shown in FIG. 4B, the field emission display device in accordance with the present invention includes: an anode upper substrate having an RGB fluorescent material and an anode electrode 61 having a lower portion to which the fluorescent material is applied, and performing light-emitting when an emitted electron collides with the fluorescent material; a cathode lower substrate having a field emission structure; and a spacer 62 supporting the upper substrate and the lower substrate therebetween. Herein, the cathode lower substrate includes: a scan electrode 69 for emitting an electron on a lower glass substrate 68; a tunnel insulation film 66 which is a path through which an electron emitted from the scan electrode 69 is emitted; a data electrode 63 for generating an electric field to control intensity of an electron when a voltage is applied thereto; a field insulation film 67 for electrically insulating the data electrode 63 and the scan electrode 69; a spacer ground layer 64 for earthing the spacer 62, and made of a mixture of aluminum (Al) and a black material (BM); and a buffer layer 65 for electrically insulating the spacer ground layer 64 and the data electrode 63, and made of a mixture of a black material and Al₂o₃, a conventional insulating material or a reflecting material, such as aluminum. To be sure, the black material includes an organic material of carbon series and a chrome (Cr) as metal material.

On the other hand, the spacer ground layer 64 may not be made of a mixture of the aluminum and the black material as mentioned, but may be made of only a black material.

Operations of the field emission display device according to the abovementioned construction will now be described.

When an anode voltage is applied between the data electrode 63 and the scan electrode 69 on a lower substrate, a strong magnetic field is formed by an electron emitting source of metal put therebetween, and an electron is emitted by a quantum-mechanical tunneling effect. Thereafter, the emitted electron is moved toward an anode electrode on an upper substrate to which a voltage of hundreds or thousands of volts has been applied, to collide with an RGB fluorescent material 60 applied onto the anode electrode 61. By this collision, an electron is excited to emit cathode rays. At this time, if the emitted electron is reflected from the anode electrode 61 to the lower substrate, the reflected electron is absorbed by the spacer ground layer 64 and the buffer layer 65 made of a mixture of an existing material and a black material, so that the electron is not re-reflected to the anode electrode 61.

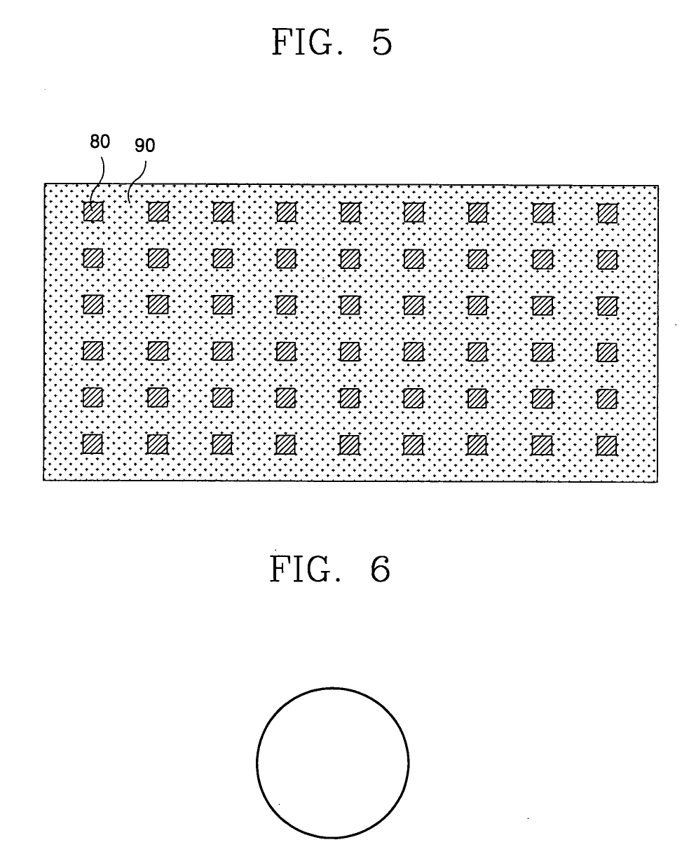

FIG. 5 is an exemplary view illustrating a region where an electron is emitted and a region where an electron is absorbed in a field emission display device in accordance with the present invention.

As shown in FIG. 5, the field emission display device in accordance with the present invention has a matrix form and consists of an electron-emitted region 80 where an electron is emitted through a scan electrode 69 and a tunnel insulation film 66, and an electron-absorbed region 90 where the reflected electron is absorbed when the emitted electron is reflected from the anode electrode 61. That is, referring to FIGS. 4A and 4B, the electron-absorbed region 90 means a region made of a mixture of an existing material and a black material (BM) in a spacer ground layer 64 and a buffer layer 65 so as to absorb an electron, or a region to which a black material layer 44 made of a black material is further included on the spacer ground layer 45.

FIG. 6 is an exemplary view illustrating a state that overlapping of an image does not occur in a field emission display device in accordance with the present invention.

As shown in FIG. 6, the field emission display device in accordance with the present invention can prevent a double image or distortion of an image from occurring because an electron reflected from an anode electrode is absorbed by a layer made of a black material or a spacer ground layer and a buffer layer made of a mixture of an existing material and the black material.

As so far described, a spacer ground layer and a buffer layer are made of a mixture of an existing material or a black material which can absorb an electron, or a black material layer made of a black material is formed on a spacer ground layer, thereby absorbing an electron reflected from an anode electrode or a fluorescent material. Accordingly, a contrast is improved, a spread of an electron beam is prevented, and a double image and distortion of an image are prevented. In addition, there is no need to attach a special filter to improve a contrast thereto.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A field emission display device comprising:
an anode upper substrate including a fluorescent material and an anode electrode for emitting light when an electron collides with the fluorescent material;
a cathode lower substrate having an electron absorbing material, which absorbs electron reflected from the anode electrode, in a predetermined region except a field emission structure for emitting an electron; and
a spacer for supporting the upper substrate and the lower substrate therebetween.

2. The device of claim 1, wherein the electron absorbing material is a black material comprising an organic material of carbon series and a chrome (Cr) as metal material.

3. The device of claim 1, where the electron field emission structure comprises:
a scan electrode for emitting an electron;
a tunnel insulation film which is a path through which an electron emitted from the scan electrode is emitted;
a data electrode generating an electric field to control intensity of an electron when a voltage is applied thereto; and
a field insulation film for electrically insulating the data electrode and the scan electrode.

4. The device of claim 3, wherein the cathode lower substrate comprises:
a spacer ground layer for earthing the spacer; and
a buffer layer for electrically insulating the spacer ground layer and the data electrode.

5. The device of claim 4, the cathode lower substrate further comprises a BM layer made of a black material absorbing an electron reflected from an anode electrode on the spacer ground layer.

6. The device of claim 5, wherein the black material comprises an organic material of carbon series and a chrome (Cr) as metal material.

7. The device of claim 4, wherein the spacer ground layer and the buffer layer are made of a mixture of an existing material and a black material which can absorb an electron, respectively.

8. The device of claim 7, wherein the spacer ground layer is made of a mixture of aluminum and a black material, and the buffer layer is made of a mixture of a black material and an insulation material including a reflection material such as Al₂0₃ or aluminum.

9. The device of claim 8, wherein the black material comprises an organic material of carbon series and a chrome (Cr) as metal material.

10. The device of claim 4, wherein the spacer ground layer is made of only a black material comprising an organic material of carbon series.

11. A field emission display device comprising:
an anode electrode for emitting light when an electron collides with a fluorescent material;
a field emission structure comprising a scan electrode for emitting an electron and a data electrode for generating an electric field to control intensity of an electron when a voltage applied thereto; and
a black material including an organic material component of carbon series and a chrome (Cr) as metal material, and for absorbing an electron reflected from the anode electrode onto the field emission structure.

12. The device of claim 11, wherein the field emission structure comprises:
a tunnel insulation film which is a path through which an electron emitted from the scan electrode is emitted; and
a field insulation film for electrically insulating the data electrode and the scan electrode.

13. The device of claim 12, further comprising
a spacer ground layer for earthing a spacer which supports an upper substrate and a lower substrate therebetween; and
a buffer layer for electrically insulating the spacer ground layer and the data electrode.

14. The device of claim 13, further comprising a BM layer made of the black material on the spacer ground layer.

15. The device of claim 13, wherein the spacer ground layer and the buffer layer are made of a mixture of an existing material and the black material which can absorb an electron.

16. The device of claim 15, wherein the spacer ground layer is made of a mixture of aluminum and the black material, and the buffer layer is made of a mixture of an insulation material and the black material.
